(19) United States
(12) Patent Application Publication
(10) Pub. No.: US 2023/0194325 A1
(43) Pub. Date: Jun. 22, 2023

(54) SYSTEMS AND METHODS FOR DETECTING FILL-LEVELS IN CROP TRANSPORT RECEPTACLES USING SWITCH-BASED SENSORS

(71) Applicant: CNH Industrial America LLC, (US)

(72) Inventor: Brittany Schroeder, Lowell, IN (US)

(21) Appl. No.: 17/552,852

(22) Filed: Dec. 16, 2021

(51) Int. Cl. G01F 23/00; G01F 23/80; A01D 41/127; A01D 41/14

(52) U.S. Cl. CPC G01F 23/0007; G01F 23/802; A01D 41/1275; A01D 41/141; A01D 41/1274

(57) ABSTRACT

In one aspect, a system for monitoring crop fill-levels of transport receptacles includes a crop transport receptacle defining a storage volume configured to receive harvested crops, and a plurality of switch-based fill-level sensors positioned within the storage volume of the crop transport receptacle. The fill-level sensors are arranged in a sensor array such that each fill-level sensor is spaced apart both vertically and horizontally relative to one or more other fill-level sensors of the plurality of fill-level sensors. In addition, the system includes a computing system communicatively coupled to the plurality of fill-level sensors, with the computing system being configured to monitor a fill-level of the crop transport receptacle based on data derived from the plurality of fill-level sensors.

### FIELD OF THE INVENTION

The present disclosure relates generally to crop transport receptacles and related transport vehicles for receiving crops during an unloading operation performed in association with a harvester and, more particularly, to systems and methods for detecting the fill-level of a crop transport receptacle using switch-based sensors.

### BACKGROUND OF THE INVENTION

Harvesters or harvesting machines pick up crop material, treat the crop material, e.g., remove any undesirable portions or residue, and discharge the crop material, Harvesters can discharge the crop material, either continuously as with a forage harvester or after intermediate storage as with a combine harvester, to a transport or transfer vehicle. The transport vehicle may be a tractor or truck pulling a cart, wagon, or trailer, or a truck or other vehicle capable of transporting harvested crop material. The harvested crop material is loaded into the transport vehicle via a crop discharging or unloading device, such as a spout or discharge auger, associated with the harvester.

During the performance of an unloading operation from a harvester to a transport vehicle, it is generally desirable to monitor the fill-level of the associated receptacle of the transport vehicle. In this regard, various vision-based systems have been proposed that utilize cameras to capture images of the harvested crops within the receptacle and then subsequently employ computer-vision techniques to process the images in an attempt to calculate or estimate the fill-level of the receptacle. However, such vision-based systems are often very complex and expensive and typically require significant computing resources to process and analyze the images in an efficient manner, particularly for “on-the-go” unloading operations.

Accordingly, systems and methods for monitoring the fill-level of a crop transport receptacle that address one or more of the issues present in the prior art would be welcomed in the technology, including, for example, systems and methods that provide a simpler (e.g., including less resource intensive) and/or more cost effective means for monitoring the fill-level within crop transport vehicles.

### SUMMARY OF THE INVENTION

Aspects and advantages of the technology will be set forth in part in the following description, or may be obvious from the description, or may be learned through practice of the technology.

In one aspect, the present subject matter is directed to a system for monitoring crop fill-levels of transport receptacles. The system includes a crop transport receptacle defining a storage volume configured to receive harvested crops, and a plurality of switch-based fill-level sensors positioned within the storage volume of the crop transport receptacle. The fill-level sensors are arranged in a sensor array such that each fill-level sensor is spaced apart both vertically and horizontally relative to one or more other fill-level sensors of the plurality of fill-level sensors. In addition, the system includes a computing system communicatively coupled to the plurality of fill-level sensors, with the computing system being configured to monitor a fill-level of the crop transport receptacle based on data derived from the plurality of fill-level sensors.

In another aspect, the present subject matter is directed to a transport vehicle for transporting harvested crops. The transport vehicle includes a traction device and a crop transport receptacle provided in association with the traction device, with the crop transport receptacle including a plurality of walls at least partially defining a storage volume configured to receive harvested crops. In addition, the transport vehicle includes a plurality of switch-based fill-level sensors positioned within the storage volume of the crop transport receptacle, with the plurality of fill-level sensors being provided on at least one wall of the plurality of walls of the crop transport receptacle in a sensor array such that each fill-level sensor is spaced apart both vertically and horizontally along the at least one wall relative to one or more other fill-level sensors of the plurality of fill-level sensors. The transport vehicle also includes a computing system communicatively coupled to the plurality of fill-level sensors, with the computing system being configured to monitor a fill-level of the crop transport receptacle based on data derived from the plurality of fill-level sensors.

In a further aspect, the present subject matter is directed to a method for monitoring a crop fill-level of a transport receptacle. The method includes receiving, with a computing system, data from a plurality of switch-based fill-level sensors provided within a storage volume of the transport receptacle as harvested crops are being received in the storage volume, with the plurality of fill-level sensors being arranged in a sensor array such that each fill-level sensor is spaced apart both vertically and horizontally relative to one or more other fill-level sensors of the plurality of fill-level sensors. In addition, the system includes monitoring, with a computing system, a fill-level of a plurality of different storage zones defined within the storage volume of the transport receptacle based on the data received from the plurality of fill-level sensors, with each fill-level sensor of the plurality of fill-level sensors being associated with a respective storage zone of the plurality of different storage zones.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a schematic top view of one embodiment of a harvester and a transport vehicle during an unloading operation in accordance with aspects of the present subject matter;

FIG. 2 illustrates a rear view of one embodiment of a harvester and a transport vehicle during an unloading operation in accordance with aspects of the present subject matter;

FIG. 3 illustrates a schematic view of one embodiment of a system for monitoring the fill-level of a crop transport receptacle in accordance with aspects of the present subject matter;

FIG. 4 illustrates a schematic, cross-sectional view of the crop transport receptacle shown in FIG. 3 taken about line 4-4, particularly illustrating one embodiment of an array of switch-based fill-level sensors that can be used to monitor the fill-level of the crop transport receptacle in accordance with aspect of the present subject matter;

FIG. 5 illustrates a similar schematic, cross-sectional view of the crop transport receptacle as that shown in FIG. 4, particularly illustrating another embodiment of an array of switch-based fill-level sensors that can be used to monitor the fill-level of the crop transport receptacle in accordance with aspect of the present subject matter; and

FIG. 6 illustrates a flow diagram of one embodiment of a method for monitoring the fill-level of a crop transport receptacle in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to systems and methods for monitoring the fill-level of crop transport receptacles, such as the fill-level of a receptacle associated with a transport vehicle that is configured to receive harvested crops from a harvester during the performance of an unloading operation. In several embodiments, the system may include one or more fill-level sensors provided in association with a crop transport receptacle and a computing system communicatively coupled to the fill-level sensor(s) for monitoring the fill-level of the receptacle based on the data received from the sensor(s).

In accordance with aspects of the present subject matter, the system may include a plurality of switch-based fill-level sensors provided in association with a crop transport receptacle. Specifically, in several embodiments, the switch-based fill-level sensors may be provided in a sensor array within the storage volume of the crop transport receptacle across one or more walls of the receptacle such that each fill-level sensor is spaced apart both vertical and horizontally from one or more other fill-level sensors of the array. For instance, the sensor array may be arranged such that fill-level sensors are provided in various vertically oriented columns and/or horizontally oriented rows and/or that the fill-level sensors are scattered across the associated wall(s) of the receptacle in a more randomized or non-uniform manner. Regardless, by providing a sensor array within the storage volume of the crop transport receptacle as described herein, the disclosed system may be configured to monitor the fill-level of individual storage zones or regions within the crop transport receptacle, thereby allowing the fill-level to be monitored in a more granular, refined manner, while still providing a simple, cost-effective means for fill-level monitoring.

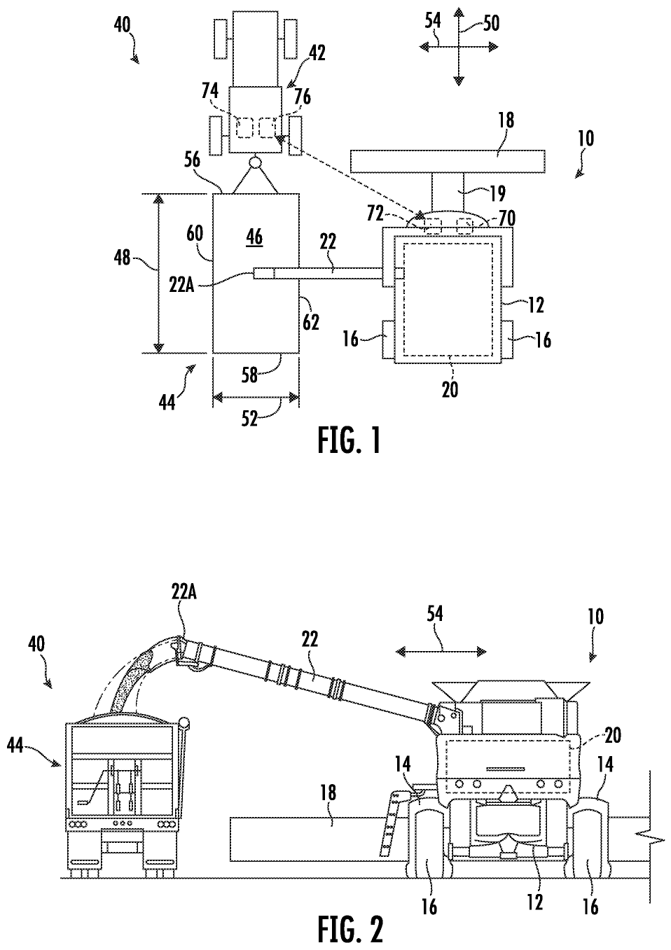

Referring now to FIGS. 1 and 2, respective top and rear views of a harvester 10 and a transport vehicle 40 during the performance of an unloading operation is illustrated in accordance with aspects of the present subject matter. As is generally understood, during a harvesting operation, crops harvested by the harvester 10 can be off-loaded immediately (e.g., in the case of forage harvesters) or temporarily stored within internal storage of the harvester (e.g., in the case of combine harvesters). Regardless, either immediately upon harvesting or after the internal storage is full or substantially full, an unloading operation is performed during which the harvested crops are unloaded from the harvester 10 to a transport vehicle 40. Such an unloading operation can be performed while the vehicles 10, 40 are stationary or can be performed “on-the-go” simultaneously with the performance of a harvesting operation. For instance, for on-the-go unloading operations, the transport vehicle 40 is typically brought into alignment with the harvester 10 such that the harvested crops can be unloaded from the harvester 10 while both vehicles 10, 40 are moving through the field. Such alignment typically includes maintaining desired offset distances between the harvester 10 and the transfer vehicle 40 (e.g., a desired lateral offset distance and/or a desired longitudinal offset distance) to ensure that the harvested crops can be properly unloaded from the harvester 10 and received by the transport vehicle 40.

In the illustrated embodiment, the harvester 10 is configured as a combine, such as an axial-flow type combine or any other suitable type of combine. In such an embodiment, the harvester 10 may include, for example, a chassis 12 and a plurality of ground engaging elements (e.g., front and rear wheels 14, 16) supporting the chassis 12 relative to the ground. In addition, the harvester 10 may include various components coupled to or supported by the chassis 12, including, but not limited to, a header 18, a feeder housing 19, an operator's cab (not shown), various internal crop processing systems and/or sub-systems (e.g., a threshing and separating system, a cleaning system, and/or the like), an internal crop storage tank 20, and an unloading tube or spout 22. The unloading spout 22 may, for example, be configured as an unloading auger, belt conveyor, chain elevator, and/or the like. Regardless of the type, the unloading spout 22 is generally configured to facilitate the transfer of harvested crops from the internal crop storage tank 20 to the transport vehicle 40 during the performance of an unloading operation. In other embodiments, it should be appreciated that the harvester 10 may have any other suitable harvester configuration, such as by being configured as a forage harvester.

In general, the transport vehicle 40 may include both a traction device 42 and a crop transport receptacle 44. As shown in the illustrated embodiment, the traction device 42 corresponds to a work vehicle, namely an agricultural tractor. However, in other embodiments, the traction device 42 may be a truck or other self-propelled vehicle sufficient to carry or tow the transport receptacle 44. Similarly, in the illustrated embodiment, the crop transport receptacle 44 corresponds to a wagon. However, in other embodiments, the transport receptacle 44 may be a grain cart, bin, or other similar storage/transport receptacle. In another embodiment, the transport vehicle 40 may be a semi-trailer truck, tractor-trailer or other similar self-propelled container vehicle.

As particularly shown in FIG. 1, the crop transport receptacle 44 may generally be configured to define a storage volume 46 for receiving/storing harvested crops. For instance, in the illustrated embodiment, the storage volume 46 has a length 48 extending in a longitudinal direction 50 between opposed front and rear walls 56, 58 of the transport receptacle 44 and a width 52 extending in a lateral direction 54 between opposed first and second sidewalls 60, 62 of the transport receptacle 44. During the performance of an unloading operation, the transport vehicle 40 is generally configured to be aligned relative to the harvester 10 such that harvested crops contained within the internal storage tank 20 of the harvester 10 can be directed through the unloading spout 22 and expelled therefrom into the storage volume 46 of the crop transport receptacle 44. Specifically, a discharge end 22A of the unloading spout 22 may generally be aligned with the transport receptacle 44 in the longitudinal and lateral directions 50, 54 such that harvested crops expelled from the spout 22 are received within the storage volume 46 of the receptacle 44. In this regard, to maintain the desired relative positioning between the discharge end 22A of the unloading spout 22 and the transport receptacle 44 during an on-the-go unloading operations, various aspects of the operation of one or both of the vehicles 10, 40 can be manually or automatically controlled/adjusted, such as by adjusting the speed and/or steering of the harvester 10 and/or the transport vehicle 40. In addition, the unloading spout 22 can be actuated to adjust the position/orientation of the spout 22 relative to the transport receptacle 44, such as by actuating the spout 22 to adjust the longitudinal position of the discharge end 22A relative to the front and rear walls 56, 58 of the receptacle 44 and/or to adjust the lateral position of the discharge end 22A relative to the first and second sidewalls 60, 62 of the receptacle 44.

Additionally, in several embodiments, both the harvester 10 and the transport vehicle 40 may include on-board computing systems and associated wireless communications devices. For instance, as shown in FIG. 1 the harvester 10 may include a harvester-based computing system 70 and wireless communications device 72, while the transport vehicle 40 may include a transport-based computing system 74 and wireless communications device 76. In such embodiments, the vehicles 10, 40 may be equipped for vehicle-to-vehicle communications, for example, by allowing data, including information, requests, instructions, control signals, and/or the like, to be transmitted between the on-board computing systems 70, 74 via the associated wireless communications devices 72, 76. As will be described below, such data may, for instance, correspond to sensor data associated with the fill-level of the crop transport receptacle 44, including data associated with the overall fill-level of the transport receptacle 44 and/or data associated with the fill-level of individual zones or regions of the transport receptacle 44.

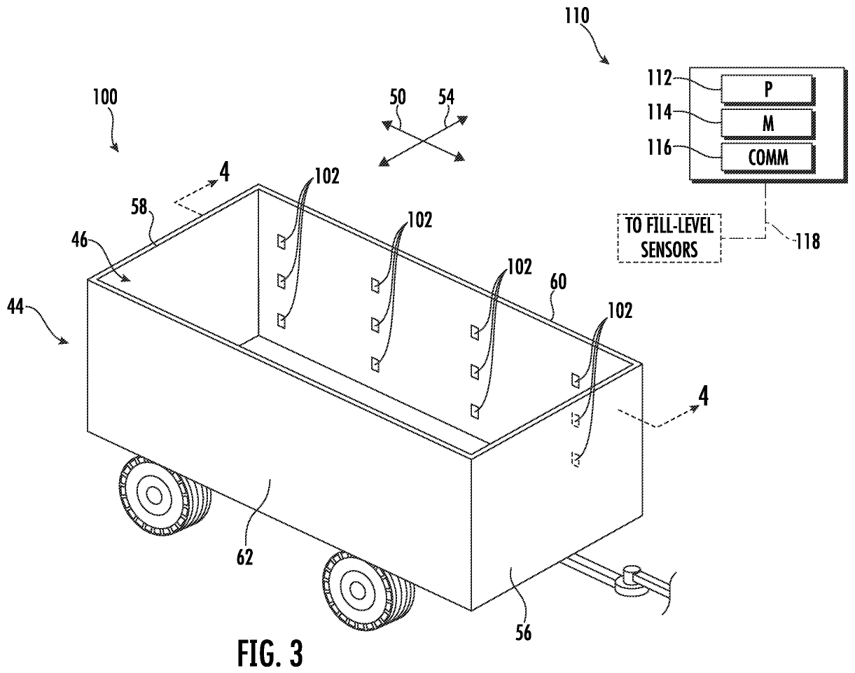

Referring now to FIG. 3, a schematic view of one embodiment of a system 100 for monitoring the fill-level of a crop transport receptacle is illustrated in accordance with aspects of the present subject matter. For purposes of discussion, the system 100 will generally be described with reference to the crop transport receptacle 44 and related transport vehicle 40 shown in FIGS. 1 and 2. However, in other embodiments, the disclosed system 100 may be configured for use with transport receptacles having any other suitable configuration, including transport receptacles provided in association with any other suitable traction device and/or forming part of any other suitable transport vehicle.

As shown in FIG. 3, the system 100 includes a crop transport receptacle (e.g., the receptacle 44 described above with reference to FIGS. 1 and 2) and one or more fill-level sensors 102 provided in operative association with the transport receptacle 44. In general, each fill-level sensor 102 is configured to generate data associated with the fill-level of all or a portion of the receptacle 44. For instance, in one embodiment, each fill-level sensor 102 may be configured to generate data associated with the overall fill-level of the receptacle 44. In addition to such data (or as an alternative thereto), each fill-level sensor 102 may be configured to generate data associated with a localized fill-level of the receptacle 44, such as the fill-level within a given region or zone of the receptacle 44. For example, the storage volume of the transport receptacle 44 may, in certain embodiments, be sub-divided into separate zones or regions. In such embodiments, the fill-level of each individual zone or region defined within the transport receptacle 44 may be monitored via one or more respective fill-level sensors 102.

In several embodiments, each fill-level sensor 102 may correspond to a switch-based fill-level sensor positioned within the interior of the crop transport receptacle 44. For instance, each fill-level sensor 102 may be configured as a contact-based pressure switch positioned on an inner surface of the crop transport receptacle, such as the inner surface defined by one or more of the walls 56, 68, 60, 62 of the crop transport receptacle 44. In such an embodiment, by positioning each switch-based fill-level sensor 102 at a given location within the crop transport receptacle 44, the sensor 102 may be configured to detect when harvested crops begin to accumulate within the receptacle 44 at or adjacent to the location of the sensor 102. For instance, when the harvested crops contact or push/press against a fill-level sensor 102 as the crops accumulate at or adjacent to the sensor 102, an internal circuit of the switch-based sensor will close (or open), thereby providing a signal (or a lack thereof as an indicator that the harvested crops have reached the level of the sensor 102 within the receptacle 44. Moreover, as will be described below, by providing an array of vertically and horizontally spaced switch-based fill-level sensors 102, the fill-level of the crop transport receptacle 44 can be monitored with more granularity. For instance, the switch-based fill-level sensors 102 may be arranged in a given pattern or array such that the fill-level of the receptacle 44 may be monitored across multiple different individual zones or regions.

Additionally, as shown in FIG. 3, the system 100 may also include a computing system 110 communicatively coupled to each fill-level sensor 102. In general, the computing system 110 may be configured to monitor the fill-level of the crop transport receptacle 44 based on data received from the fill-level sensors 102 (e.g., data indicative of a signal or the lack thereof). For instance, the computing system 110 may include suitable algorithms, mathematical formulas or expressions, predetermination relationships, correlation tables, look-up tables, and/or other data stored within its memory that allows the computing system 110 to determine, calculate, or estimate the fill-level within all or a portion of the receptacle 44 based on the data received from the fill-level sensors 102.

In general, the computing system 110 may comprise any suitable processor-based device known in the art, such as a computing device or any suitable combination of computing devices. Thus, in several embodiments, the computing system 110 may include one or more processor(s) 112 and associated memory-device(s) 114 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 114 of the computing system 110 may generally comprise memory element(s) including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 114 may generally be configured to store suitable computer-readable instructions that, when implemented by the processor(s) 112, configure the computing system 110 to perform various computer-implemented functions, such as one or more aspects of the methods or algorithms described herein. In addition, the computing system 110 may also include various other suitable components, such as a communications circuit or module, one or more input/output channels, a data/control bus and/or the like. For instance, the computing system 110 may include a communications module or interface 116 to allow the computing system 110 to communicate with any of the various other system components described herein, such as the fill-level sensors 102. Specifically, as shown schematically in FIG. 3, the communications module 116 may be communicatively coupled to each fill-level sensor 102 via one or more communicative links 118 to allow data to be transmitted from the fill-level sensors 102 to the computing system 110.

It should be appreciated that, in several embodiments, the computing system 110 may correspond to a stand-alone computing system configured to monitor the fill-level of the crop transport receptacle 44. In such embodiments, the computing system 110 may, for instance, be configured to communicate data related to the fill-level of the transport receptacle 44 to one or more separate computing systems, such as by communicating the data to the on-board computing system of an associated transport vehicle and/or harvester (e.g., on-board computing systems 70, 74 shown in FIG. 1). Additionally, in some embodiments, the computing system 110 may correspond to or form part of an existing on-board computing system, such as the on-board computing system of an associated transport vehicle (e.g., computing system 74 (FIG. 1)).

In several embodiments, based on the monitored fill-level of the crop transport receptacle 44, the computing system 110 may be configured to initiate one or more control actions during the performance of an unloading operation to adjust the operation of a related transport vehicle and/or harvester (e.g., the transport vehicle 40 and/or harvester 10 described above with reference to FIGS. 1 and 2). For instance, it may be desirable to fill the crop transport receptacle 44 according to a predetermined filling strategy, such as by filling the receptacle 44 front-to-back in the longitudinal direction 50, side-to-side in the lateral direction 54, or according to a zone-based filling scheme. In such instance, to implement the desired filling strategy, the relative position between the transport receptacle 44 and the unloading spout 22 (FIGS. 1 and 2) of the harvester 10 may be adjusted as different sections or zones of the receptacle 44 begin to fill-up (e.g., as monitored via the data from the fill-level sensors 102). In one embodiment, a transport-based control action may be executed to adjust the relative position between the transport receptacle 44 and the unloading spout 22, such as by adjusting the speed of the transport vehicle 40 (e.g., speeding up or slowing down) or by adjusting the heading of the transport vehicle 40 (e.g., by steering the vehicle 40 left or right relative to the harvester 10). In another embodiment, a harvester-based control action may be executed to adjust the relative position between the transport receptacle 44 and the unloading spout 22, such as by adjusting the speed of the harvester 10 (e.g., speeding up or slowing down), by adjusting the heading of the harvester 10 (e.g., by steering the harvester 10 left or right relative to the vehicle 10), or by implementing spout control to acuate the spout 22 relative to the remainder of the harvester 10.

It should be appreciated that the computing system 110 may be configured to initiate control actions to adjust the relative position between the transport receptacle 44 and the unloading spout 22 in any suitable manner. For instance, in one embodiment, control actions may be initiated by transmitting the fill-level sensor data (or the current fill-level as determined based on the sensor data) from the computing system 110 to a separate computing system (e.g., the on-board computing system(s) 70, 74 of the transport vehicle 40 and/or the harvester 10), at which point the separate computing system may be configured to process/analyze the sensor data and transmit control signals for executing a suitable control action(s) to make a desired adjustment(s) in the relative positioning between the transport receptacle 44 and the unloading spout 22, including the transmission of control signals associated with instructions or requests for executing the desired adjustments. In other embodiments, the computing system 110 may be configured to process/analyze the sensor data and subsequently transmit, itself, control signals for executing a suitable control action(s) to make a desired adjustment(s) in the relative positioning between the transport receptacle 44 and the unloading spout 22, including the transmission of control signals associated with instructions or requests for executing the desired adjustments.

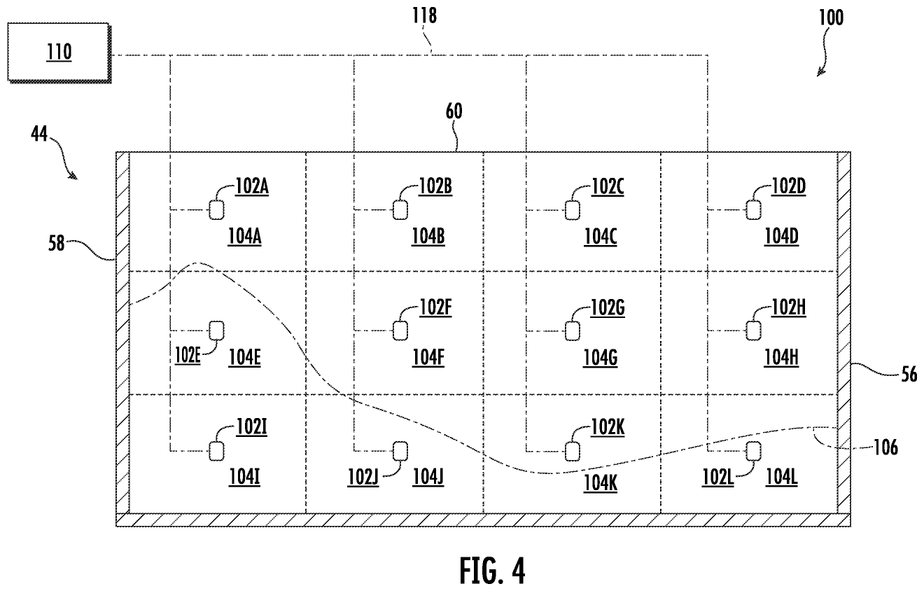

Referring now to FIG. 4, a schematic, cross-sectional view of a portion of the crop transport receptacle 44 shown in FIG. 3 taken about line 4-4 is illustrated in accordance with aspects of the present subject matter, particularly illustrating an exemplary pattern or array of switch-based fill-level sensors 102 for monitoring the fill-level of the receptacle 44. As shown in FIG. 4, the storage volume 46 (FIG. 3) of the crop transport receptacle 44 has been sub-divided into an array of separate regions or zones 104. Specifically, in the illustrated embodiment, the storage volume 46 has been sub-divided into a 3×4 array of storage zones (e.g., zones 104A-104L) including three horizontal rows of four storage zones 104 each (or four vertical columns of three storage zones 104 each). In such an embodiment, one or more fill-level sensors 102 may be provided in association with each storage zone 104. For instance, in the illustrated embodiment, a plurality of fill-level sensors (102A-102L) has been installed on the adjacent wall of the crop transport receptacle 44 (e.g., wall 60) such that each fill-level sensor 102 is associated with a respective storage zone 104, thereby allowing each sensor 102 to provide an indication of the fill-level of its respective zone 104. Specifically, each fill-level sensor 102 may be configured to provide an indication as to when the localized fill-level of the receptacle 44 reaches a given threshold level within the respective storage zone 104.

It should be appreciated that the specific pattern or array of fill-level sensors 102 shown in FIG. 4 (along with the associated array of storage zones 104) is simply provided as an exemplary sensor pattern or array that can be utilized in accordance with aspects of the present subject matter. In other embodiments, any other suitable pattern or array of sensors may be used, including the use of more or less fill-level sensors 102. For instance, as opposed to an array of vertically/horizontally arranged rows/columns, the sensor array may be more randomized or arranged in an offset manner. In many instances, the specific pattern or array of fill-level sensors 102 will vary depending on the configuration of the crop transport receptacle 44, including the shape of the internal storage volume defined by the receptacle 44.

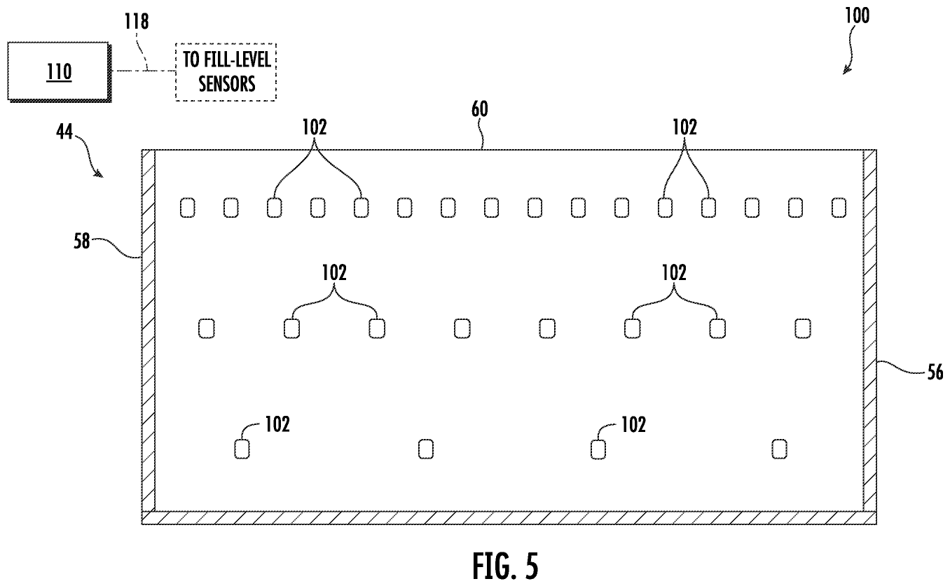

As another illustrative embodiment, FIG. 5 provides an exemplary sensor array in which the fill-level sensors 102 are vertically and horizontally spaced similar to the embodiment shown in FIG. 4, but are spaced and distributed in a more non-uniform manner (as opposed to the embodiment shown in FIG. 4), Specifically, in the embodiment shown in FIG. 5, the number of fill-level sensors 102 provided at a given vertical location within the receptacle 44 increases from the bottom of the receptacle 44 to the top, while the horizontal spacing between such sensors 102 decreases from the bottom of the receptacle 44 to the top. As a result, more granular or refined fill-level data may be provided as the receptacle 44 begins to fill-up, thereby allowing finer adjustments to be made to ensure that the receptacle 44 can be properly filled without overflowing harvested crops.

Referring back to FIG. 4, as indicated above, by providing an array of switch-based fill-level sensors 102 across various different storage zones 104 of the crop transport receptacle 44, the computing system 110 may be configured to automatically monitor the fill-level within each storage zone 104. For instance, a representative crop material fill line 106 is illustrated in FIG. 4 providing an example fill-level within the crop transport receptacle 44. With such an exemplary fill-level, four of the switch-based fill-level sensors 102 have been triggered due to harvested crops accumulating up to the level of such sensors (i.e., sensors 102E, 102I, 102J, and 102L), thereby indicating that their respective storage zones (i.e., zones 104E, 104I, 104J, and 104L) have reached a given threshold fill-level. Based on such information, the computing system 110 may determine that, for instance, the back-end of the receptacle 44 is fuller than the front-end of the receptacle 44 (e.g., due to two sensors 102E, 102I positioned adjacent to the receptacle's back wall 58 being triggered as opposed to the single sensor 102L adjacent to the receptacle's front wall 56 being triggered). Moreover, given that one of the more centrally located sensors 102 in the bottom row has not been triggered (i.e., sensor 102K), the computing system 110 may determine that a non-uniform or varying fill-level has been achieved within the receptacle 44. As a result, the computing system 110 may, in certain embodiments, be configured to initiate a control action to adjust the relative position between the transport receptacle 44 and the unloading spout 22 to even-out the crop distribution with the receptacle 44, such as by adjusting the relative position so that more crop material is directed into the front-half of the receptacle 44.

It should be appreciated that, although fill-level sensors 102 have only been shown in the illustrated embodiments as being installed on a single receptacle wall, the sensors 102 may be installed on any combination of walls 56, 58, 60, 62 of the receptacle 44. For instance, referring back to FIG. 3, although fill-level sensors 102 are only shown as being installed as a sensor array along the first sidewall 60 of the receptacle 44, the same or a similar sensor array may also be installed along the opposed second sidewall 62 of the receptacle 44. In such an embodiment, the storage volume of the transport receptacle 44 may be subdivided in a similar manner as described above (e.g., a. 3×4 array) along each side of a longitudinal centerline of the crop transport receptacle 44, thereby significantly increasing (e.g., doubling) the number of individual storage zones 104 defined within the storage volume. Similarly, by providing an array of fill-level sensors along the front and rear walls 56, 58 of the transport receptacle 44, more-refined information may be obtained regarding the fill-level adjacent to the front and rear ends of the receptacle 44.

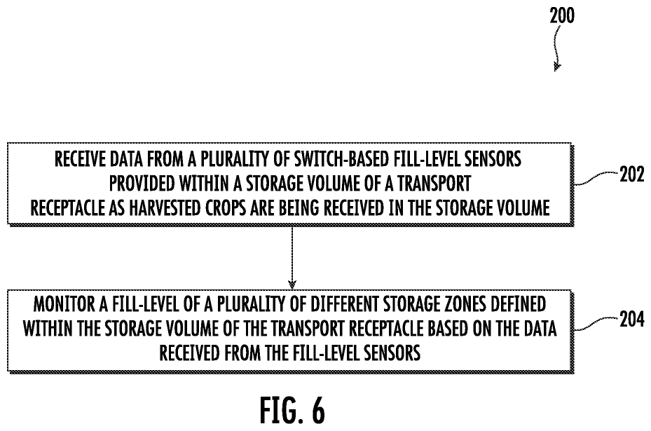

Referring now to FIG. 6, a flow diagram of one embodiment of a method 200 for monitoring the fill-level of a crop transport receptacle is illustrated in accordance with aspects of the present subject matter. In general, the method 200 will be described herein with reference to the crop transport receptacle 44 and system 100 described above with reference to FIGS. 1-5. However, it should be appreciated by those of ordinary skill in the art that the disclosed method 200 may generally be utilized in association with transport receptacles having any suitable receptacle configuration and/or with systems having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (202), the method 200 may include receiving data from a plurality of switch-based fill-level sensors provided within a storage volume of a transport receptacle as harvested crops are being received in the storage volume. Specifically, as indicated above, the computing system 110 may be communicatively coupled to an array of switch-based fill-level sensors 102 provided in association with a given transport receptacle 44. For instance, the array of fill-level sensors 102 may be arranged such that each sensor 102 is spaced apart both vertically and horizontally from one or more other sensors 102 of the array (e.g., as shown in the embodiments of FIGS. 4 and 5)

Additionally, at (204), the method 200 may include monitoring a fill-level of a plurality of different storage zones defined within the storage volume of the transport receptacle based on the data received from the fill-level sensors. For instance, as indicated above, in one embodiment, a plurality of different storage zones 104 may be defined within the transport receptacle 44, with each fill-level sensor 102 being associated with a respective storage zone 104. In such an embodiment, the computing system 100 may be configured to monitor the fill-level of each individual storage zone 104 based on the data received from the respective fill-level sensor 102.

It should also be appreciated that the disclosed method 200 may also include initiating a control action to adjust a relative position between an unloading spout of an associated harvester and the transport receptacle based on the monitored fill-level of the plurality of different storage zones. For instance, as indicated above, the computing system 110 may be configured to initiate a control action to adjust the relative positioning between the spout 22 and the receptacle 44 to ensure a desired distribution of the harvested crops within the receptacle 44 and/or to follow a predetermined fill strategy for the receptacle 44.

It is to be understood that the steps of the method 200 are performed by the computing system 110 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 110 described herein, such as the method 200, is implemented in software code or instructions which are tangibly stored on a tangible computer readable medium. The computing system 110 loads the software code or instructions via a direct interface with the computer readable medium or via a wired and/or wireless network. Upon loading and executing such software code or instructions by the computing system 110, the computing system 110 may perform any of the functionality of the computing system 110 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system monitoring crop fill-levels of transport receptacles, the system comprising:
a crop transport receptacle defining a storage volume configured to receive harvested crops;
a plurality of switch-based fill-level sensors positioned within the storage volume of the crop transport receptacle, the plurality of fill-level sensors being arranged in a sensor array such that each fill-level sensor is spaced apart both vertically and horizontally relative to one or more other fill-level sensors of the plurality of fill-level sensors;
a computing system communicatively coupled to the plurality of fill-level sensors, the computing system being configured to monitor a fill-level of the crop transport receptacle based on data derived from the plurality of fill-level sensors.

2. The system of claim 1, wherein the storage volume of the crop transport receptacle is sub-divided into a plurality of horizontally and vertically spaced storage zones, wherein each fill-level sensor of the plurality of fill-level sensors is associated with a respective storage zone of the plurality of storage zones.

3. The system of claim 2, wherein the computing system is configured to monitor a fill-level of each respective storage zone of the plurality of storage zones based on the data derived from the plurality of fill-level sensors.

4. The system of claim 1, wherein the storage volume of the crop transport receptacle is at least partially defined by a plurality of walls of the crop transport receptacle, the sensor array being provided on a wall of the plurality of walls of the crop transport receptacle.

5. The system of claim 4, wherein the plurality of walls includes a front wall, a rear wall spaced apart from the front wall in a longitudinal direction of the crop transport receptacle, and opposed first and second sidewalls spaced apart from each other in a lateral direction of the crop transport receptacle, the sensor array being provided on at least one of the first sidewall or the second sidewall of the crop transport receptacle.

6. The system of claim 1, wherein the sensor array is arranged such that sets of the plurality of fill-level sensors are aligned in at least one of horizontal rows or vertical columns.

7. The system of claim 1, wherein each fill-level sensor comprises a contact-based pressure sensor that is configured to open or close an internal circuit of the fill-level sensor upon harvested crops accumulating against and contacting the fill-level sensor.

8. A transport vehicle for transporting harvested crops, the transport vehicle comprising:
a traction device;
a crop transport receptacle provided in association with the traction device, the crop transport receptacle including a plurality of walls at least partially defining a storage volume configured to receive harvested crops;
a plurality of switch-based fill-level sensors positioned within the storage volume of the crop transport receptacle, the plurality of fill-level sensors being provided on at least one wall of the plurality of walls of the crop transport receptacle in a sensor array such that each fill-level sensor is spaced apart both vertically and horizontally along the at least one wall relative to one or more other fill-level sensors of the plurality of fill-level sensors;
a computing system communicatively coupled to the plurality of fill-level sensors, the computing system being configured to monitor a fill-level of the crop transport receptacle based on data derived from the plurality of fill-level sensors.

9. The transport vehicle of claim 8, wherein the storage volume of the crop transport receptacle is sub-divided into a plurality of horizontally and vertically spaced storage zones, wherein each fill-level sensor of the plurality of fill-level sensors is associated with a respective storage zone of the plurality of storage zones.

10. The transport vehicle of claim 9, wherein the computing system is configured to monitor a fill-level of each respective storage zone of the plurality of storage zones based on the data derived from the plurality of fill-level sensors.

11. The transport vehicle of claim 8, wherein the plurality of walls includes a front wall, a rear wall spaced apart from the front wall in a longitudinal direction of the crop transport receptacle, and opposed first and second sidewalls spaced apart from each other in a lateral direction of the crop transport receptacle, the sensor array being provided on at least one or the first sidewall of the second sidewall of the crop transport receptacle.

12. The transport vehicle of claim 8, wherein the sensor array is arranged such that sets of the plurality of fill-level sensors are aligned in at least one of horizontal rows or vertical columns.

13. The transport vehicle of claim 8, wherein each fill-level sensor comprises a contact-based pressure sensor that is configured to open or close an internal circuit of the fill-level sensor upon harvested crops accumulating against and contact the fill-level sensor.

14. A method for monitoring a crop fill-level of a transport receptacle, the method comprising:
receiving, with a computing system, data from a plurality of switch-based fill-level sensors provided within a storage volume of the transport receptacle as harvested crops are being received in the storage volume, the plurality of fill-level sensors being arranged in a sensor array such that each fill-level sensor is spaced apart both vertically and horizontally relative to one or more other fill-level sensors of the plurality of fill-level sensors;
monitoring, with a computing system, a fill-level of a plurality of different storage zones defined within the storage volume of the transport receptacle based on the data received from the plurality of fill-level sensors, each fill-level sensor of the plurality of fill-level sensors being associated with a respective storage zone of the plurality of different storage zones.

15. The method of claim 14, wherein the harvested crops are being received in the storage volume of the transport receptacle from a harvester during the performance of an unloading operation.

16. The method of claim 15, further comprising initiating a control action to adjust a relative position between an unloading spout of the harvester and the transport receptacle based on the monitored fill-level of the plurality of different storage zones.

17. The method of claim 16, wherein initiating the control action comprises initiating a control action associated with adjusting an operation of the harvester.

18. The method of claim 17, wherein the control action is associated with adjusting a speed or a heading of the harvester or adjusting a relative position of the spout of the harvester.

19. The method of claim 16, wherein initiating the control action comprises initiating a control action associated with adjusting an operation of a transport vehicle associated with the transport receptacle.

20. The method of claim 19, wherein the control action is associated with adjusting a speed or a heading of the transport vehicle.
